(19) United States
(12) Patent Application Publication
(10) Pub. No.: US 2004/0025603 A1
(43) Pub. Date: Feb. 12, 2004

(54) Test tube insert

(76) Inventors: John Liseo, Cromwell, CT (US); Richard H. Hawley, Torrington, CT (US); Todd DeMatteo, Farmington, CT (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/290,926

(22) Filed: Nov. 8, 2002

Related U.S. Application Data
(63) Continuation-in-part of application No. 10/214,016, filed on Aug. 7, 2002.

(51) Int. Cl. G01N 1/40; B01L 3/14

(52) U.S. Cl. 73/863.21; 73/864.91; 422/101; 436/177

(57) ABSTRACT

A fluid collection apparatus is provided including an insert configured for disposal within a tube. The insert includes a first diameter, a second diameter and defines a chamber therebetween. The chamber extends from a closed end to an open end that is configured for receipt of a fluid sample. The second diameter may define an interior cavity of the insert. The interior cavity may include a base portion and a barrel portion. A method for collecting sediment from a fluid sample is disclosed.

### CROSS-REFERENCE TO RELATED APPLICATION

This patent application is a continuation-in-part of U.S. Utility patent application Ser. No. 10/214,016, filed in the U.S. Patent and Trademark Office on Aug. 7, 2002 by Liseo et al., the entire contents of which being hereby incorporated by reference herein.

### BACKGROUND

1. Technical Field

The present disclosure generally relates to the field of body fluid specimen collection for medical diagnosis, and more particularly, to a fluid collection apparatus that employs an insert to collect sediment, cellular components and other particulate matter from a fluid sample.

2. Description of the Related Art

Medical diagnosis of a patient condition for disease, illness, etc. often includes collection of body fluids, such as, for example, urine, blood, cerebrospinal fluid, etc. for testing. One such diagnostic procedure is urinalysis. Typical urinalysis testing is performed in most hospitals, doctors' offices and commercial laboratories. There are approximately 200 million such procedures performed annually in the United States, and by some estimates over 1 billion performed worldwide.

Urinalysis may be employed to detect various diseases such as, for example, cancerous cellular matter, tumors, stones, diabetes mellitus, glomerulonephritis, urinary tract infections and other inflammatory diseases. Urinalysis typically includes collection of a urine sample having urinary sediment. Urinary sediment consist of cells and particulate matter disposed with the urinary tract. Urinary sediment can include red blood cells, white blood cells, epithelial cells, casts, etc. The sediment may also include bacteria, yeast and parasites.

Examination during urinalysis may include direct visual observation and chemical analysis. Chemical analysis of urine is performed using one of many different urine dip sticks available from a variety of manufacturers. These dip sticks or reagent strips consist of a plastic strip which contains one or more chemically impregnated reaction pads. A color reaction develops upon contact of the urine and the reagent pads. Chemical analyses, however, can suffer from reliability and integrity drawbacks. For example, a doctor, nurse, or assistant is capable of misreading or misinterpreting the results. Moreover, bacteria in the sediments may destroy glucose and pH changes that may occur if the urine is allowed to stand.

Another method of analyzing urine and urinary sediments is microscopic urinalysis. In operation, a sample of well-mixed urine, typically 10-15 milliliters, is centrifuged in a test tube at relatively low speed, approximately, 2000-3000 revolutions per minute, for 5-10 minutes until a moderately cohesive button (concentration of urine sediment) is produced at the bottom of the test tube. A clinician pours off or decants all of the excess fluid, namely supernatant.

The supernatant is decanted and a volume of 0.2 to 0.5 ml is left inside the tube. The clinician draws an amount of the button, using for example, a pipette. The sediment is resuspended in the remaining supernatant. A drop of resuspended sediment is disposed onto a glass slide and coverslipped. The glass slide is positioned onto a stage of a microscope and examined. At the end of the examination, the glass slide, cover slip and pipette are thrown away.

Various urinalysis devices are known for collection of urine and urinary sediment. See, for example, U.S. Pat. Nos. 3,777,739; 3,881,465; 4,042,337 and 4,084,937. These types of devices for performing traditional procedures for routine urine analysis suffer from various drawbacks. Utilizing these devices can be labor intensive and require many disposal items per test. Further, they may be prone to variations in and among tests, and expose the clinician to potentially hazardous materials contained in the specimen.

Attempts have been made to overcome the drawbacks of the prior art. Some devices use an inner tube mounted to an open end of a test tube. See, for example, U.S. Pat. No. 5,725,832. These type devices, however, disadvantageously, require slow and careful manipulation whereby procedural success is dependent on the skill level of the medical personnel. Further, the inner tube may require dimension constraints according to test tube and specimen size. This can disadvantageously result in high production costs due to their complexity

Therefore, it would be desirable, to overcome the disadvantages and drawbacks of the prior art with a fluid collection apparatus including an insert that collects sediment, cellular components and other particulate matter from a fluid sample while reducing associated labor and cost burdens. It would be highly desirable if the insert collected at least a portion of a fluid sample to facilitate various forms of urinalysis. It is contemplated that the fluid collection apparatus is easily and efficiently manufactured and assembled.

### SUMMARY

Accordingly, a fluid collection apparatus is provided that includes an insert that collects sediment, cellular components and other particulate matter from a fluid sample while reducing associated labor and cost burdens to overcome the disadvantages and drawbacks of the prior art. Desirably, the insert collects at least a portion of a fluid sample to facilitate various forms of urinalysis. The fluid collection apparatus is easily and efficiently manufactured and assembled. The present disclosure resolves related disadvantages and drawbacks experienced in the art.

For example, some of the advantages of the present disclosure include an air pocket chamber designed to hold a sufficient amount of a fluid sample, such as, one milliliter (ml) after a decanting procedure is performed so that the remaining fluid sample can mix with sediment collected at a closed end of a test tube to perform further testing. Sediment collected adjacent to the closed end may also be resuspended in the remaining fluid sample. Further, the insert can be advantageously dimensioned to facilitate use of chemical test strips.

In one particular embodiment, in accordance with the principles of the present disclosure, a fluid collection apparatus is provided including a tube defining a longitudinal axis and extending therealong from a closed end to an open end. The tube further defines an inner surface. An insert is configured for disposal within the tube and recessed from the open end. The insert includes a first diameter configured and dimensioned for engagement with the inner surface of the tube and a second diameter configured and dimensioned to form a chamber with the inner surface of the tube. The insert may define an interior cavity.

The insert may include a transition diameter disposed intermediate the first diameter and the second diameter. The transition diameter can be substantially tapered relative to the longitudinal axis. The second diameter may include at least one radially extending rib being configured and dimensioned to engage the inner surface of the tube. The first diameter may have a larger dimension relative to the second diameter. The insert can be disposed adjacent the closed end.

In an alternate embodiment, the tube is tapered relative to the longitudinal axis thereof.

In another alternate embodiment, the fluid collection apparatus includes an insert configured for disposal within a tube. The insert includes a first diameter, a second diameter and defines a chamber therebetween. The chamber extends from a closed end to an open end that is configured for receipt of a fluid sample. The second diameter may define an interior cavity of the insert. The interior cavity may include a base portion and a barrel portion.

A method for collecting sediment from a fluid sample is disclosed including the steps of: providing a fluid collection apparatus, similar to that described, disposing a fluid sample within a tube of the fluid collection apparatus; collecting a concentration of sediment from the fluid sample adjacent a closed end of the tube; inverting an orientation of the tube such that at least a portion of the concentration of sediment is disposed with a chamber defined by the test tube and the insert. The method may further include the step of decanting a supernatant portion of the fluid sample. The method may further include the step of suspending the portion of the concentration of sediment in a portion of the fluid sample. The method may further include the step of disposing the portion of the concentration of sediment on a microscope slide. The step of collecting may include centrifuging the fluid sample disposed in the tube.

In an alternate embodiment, the method includes the step of inverting the tube from a first orientation to a second orientation such that at least a portion of the concentration of sediment is disposed with the chamber of the insert.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings wherein:

FIG. 1 is a side view of a fluid collection apparatus, in accordance with the principles of the present disclosure;

FIG. 2 is an alternate side view, in part cross-section, of the fluid collection apparatus shown in FIG. 1;

FIG. 3 is a side view of an insert of the fluid collection apparatus shown in FIG. 1;

FIG. 4 is an enlarged side cross-sectional view of the insert shown in FIG. 3;

FIG. 5 is a bottom view of the insert shown in FIG. 3;

FIG. 6 is a top view of the insert shown in FIG. 3;

FIG. 7 is a side view of the fluid collection apparatus shown in FIG. 1 in an upright position having a fluid sample disposed therein;

FIG. 8 is a side view of the fluid collection apparatus shown in FIG. 7 in an inverted position;

FIG. 9 is a side cross-sectional view of an alternate embodiment of the insert shown in FIG. 1; and

FIG. 10 is a top view of the insert shown in FIG. 9.

### DETAILED DESCRIPTION OF EXEMPLARY EMBODIMENTS

The exemplary embodiments of the fluid collection apparatus and methods of operation disclosed are discussed in terms of body fluid specimen collection for medical diagnosis, and more particularly, in terms of a fluid collection apparatus that employs an insert to collect sediment, cellular components and other particulate matter from a fluid sample. It is contemplated that the fluid collection apparatus of the present disclosure is employed for collection of a urine sample having urinary sediment for performing urinalysis. Testing and corresponding diagnosis associated with the urinalysis procedure is used to detect various diseases such as, for example, cancerous cellular matter, tumors, stones, diabetes mellitus, glomerulonephritis, urinary tract infections and other inflammatory diseases. Glucose levels may also be detected. It is envisioned that the fluid collection apparatus may facilitate various methods of testing associated with urinalysis such as, for example, direct visual observation, chemical analysis, other macroscopic analyses and microscopic analyses. It is further envisioned that the present disclosure also finds application for the collection of body fluids, such as, for example, blood, cerebral fluid, spinal fluid, etc. for testing.

In the discussion that follows, the term “fluid sample” will refer to a collected body fluid that may include sediment. It is contemplated that the sediment, as discussed herein, may include cellular components and other particulate matter. As used herein, the term “subject” refers to a patient undergoing a procedure that requires a fluid sample from the subject. According to the present disclosure, the term “practitioner” refers to an individual collecting the fluid sample from the subject, performing various steps in a procedure, etc., or otherwise employing the fluid collection apparatus, and may include support personnel.

The component parts of the fluid collection apparatus are fabricated from materials suitable for fluid sample collection, testing and diagnosis, such as, for example, medical grade glass, polymerics or metals, such as stainless steel, depending on the particular fluid collection apparatus application and/or preference of a practitioner. Semi-rigid and rigid polymerics are contemplated for fabrication, as well as resilient materials, such as molded medical grade polypropylene. It is contemplated that the component parts of the fluid collection apparatus may be integrally assembled or, alternatively, monolithically formed according to the specifications and cost constraints of a particular fluid sample testing and diagnostic application. One skilled in the art, however, will realize that other materials and fabrication methods suitable for assembly and manufacture, in accordance with the present disclosure, also would be appropriate.

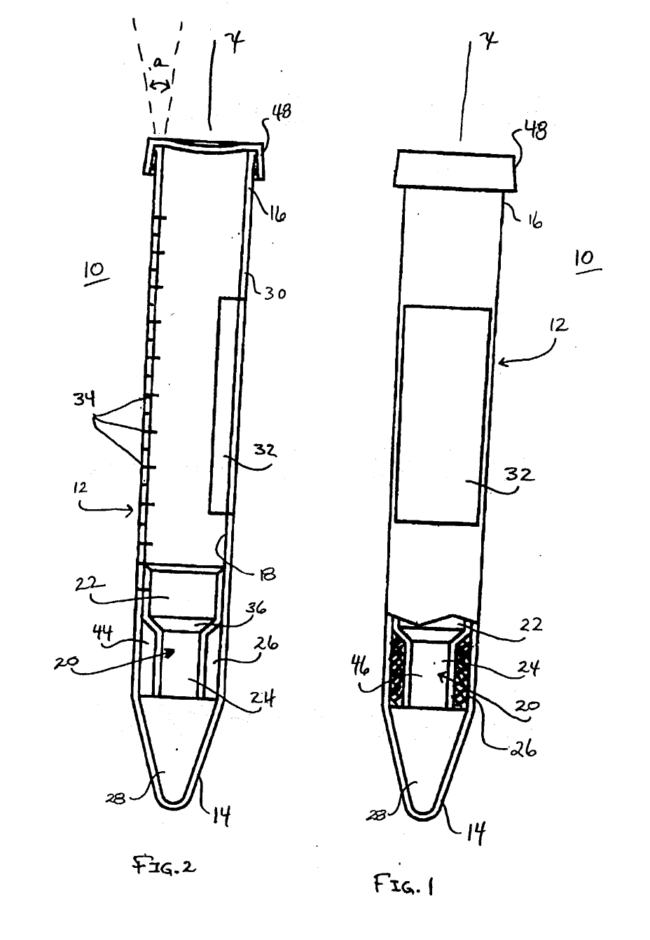

Reference will be now be made in detail to the exemplary embodiments of the disclosure, which are illustrated in the accompanying figures. Turning now to the figures wherein like components are designated by like reference numerals throughout the several views and initially to FIGS. 1 and 2, there is illustrated a fluid collection apparatus 10, in accordance with the principles of the present disclosure.

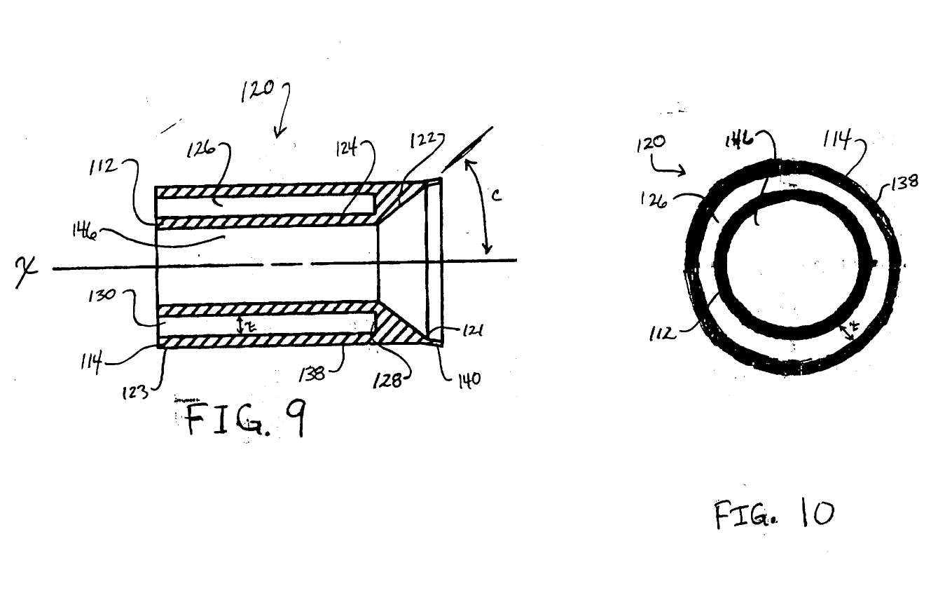

Fluid collection apparatus 10 includes a test tube 12 defining a longitudinal axis x. Test tube 12 extends along longitudinal axis x from a closed end 14 to an open end 16. Test tube 12 further defines an inner surface 18. An insert 20 is configured for disposal with test tube 12 and recessed from open end 16. Insert 20 includes a first diameter such as, for example, base portion 22 that is configured and dimensioned for engagement with inner surface 18. Insert 20 further includes a second diameter such as, for example, barrel portion 24 that is configured and dimensioned to form a chamber 26 with inner surface 18. Insert 20 is disposed within test tube 12 for collecting sediment from a fluid sample F (FIGS. 7 and 8).

Insert 20 advantageously reduces the amount of labor required for a fluid collection application, which thereby reduces the potential for practitioner error. Insert 20 is also configured to retain a portion of fluid sample F, allowing resuspension of sediment S (FIGS. 7 and 8) and facilitating various urinalysis procedures, as will be discussed.

Test tube 12 is cylindrical and configured for centrifuge of fluid sample F disposed therein. It is contemplated that a commercially available test tube vessel is employed although other laboratory vessels, flasks, etc. may be used according to the specific requirements of a fluid collection analysis. It is further contemplated that test tube 12 may have other geometric cross-sectional configurations such as, for example, elliptical, rectangular, etc.

Closed end 14 includes a nose portion 28 configured to collect sediment S separated from fluid sample F after centrifuge. A wall portion 30 of test tube 12 is tapered, from closed end 14 to open end 16 at an angular orientation a relative to longitudinal axis x. Tapered wall portion 30 facilitates a sealing engagement with insert 20, as will be discussed, allowing collection of sediment S from fluid sample F. It is contemplated that wall portion 30 may be tapered at various angular orientations, or alternatively, in substantially parallel alignment with longitudinal axis x.

Test tube 12 includes visual indicators such as label 32 and graduations 34. Label 32 provides an indication to a practitioner of the specific contents. Graduations 34 provide an indication of sample volume facilitating adjustment of concentration and dilution ratios.

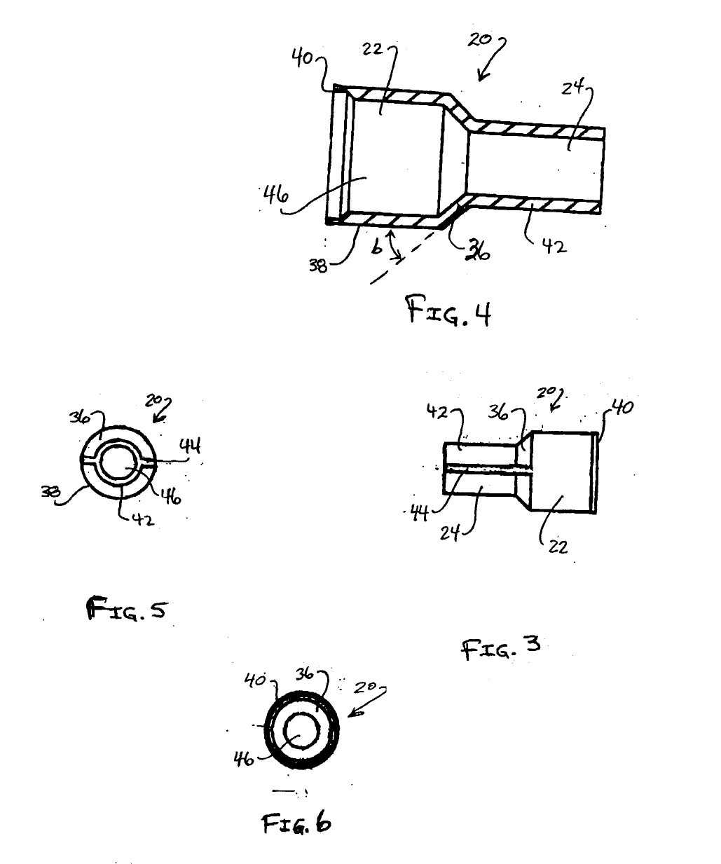

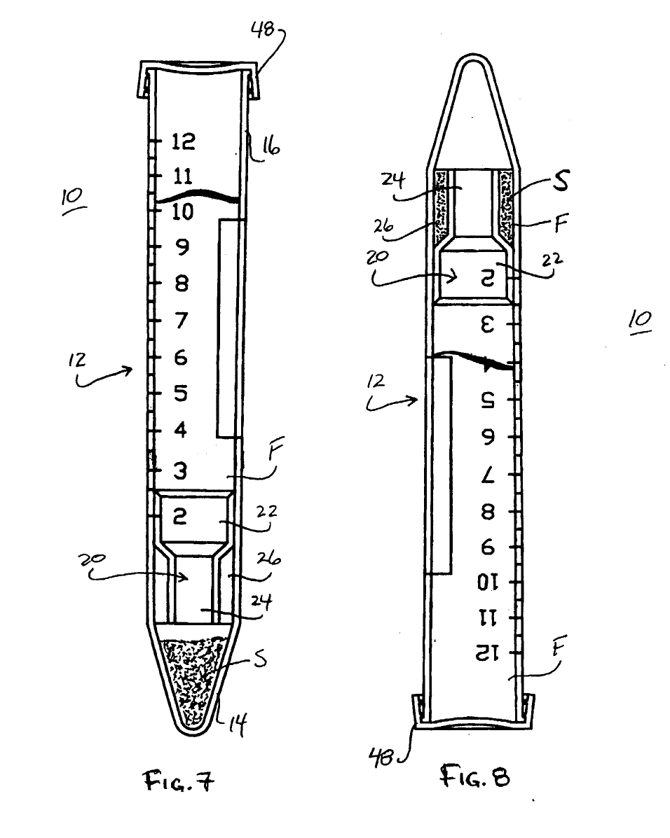

Insert 20 extends from base portion 22 to barrel portion 24 via an intermediate transition diameter 36. Base portion 22 has a larger relative dimension to barrel portion 24. Referring to FIGS. 3-6, transition diameter 36 is substantially tapered at an angular orientation b relative to longitudinal axis x. The tapered configuration of transition diameter 36 in cooperation with the relative dimension of base portion 22 and barrel portion 24 facilitates support of base portion 22 by inner surface 18 of test tube 12. In turn, this allows barrel portion 24 to form chamber 26, which facilitates collection of sediment S.

Generally, insert 20 may be manufactured in a manner, size and shape, which presents a frictional fit or bias on the inner surface 18 of the test tube 12. It is also contemplated herein that insert 20 be ultrasonically welded or fastened using adhesive with inner surface 18 of test tube 12. It is also contemplated herein that test tube 12 and insert 20 be monolithically or separately formed from polymeric materials. Base portion 22 includes an outer surface 38, which is configured for flush engagement with inner surface 18. This engagement provides a fluid seal which allows insert 20 to collect a portion of fluid sample F and sediment S within chamber 26. Base portion 22 also includes a flange 40 that facilitates passage of fluid sample F to closed end 14. Barrel portion 24 includes outer surface 42 that cooperates with inner surface 18 to form chamber 26. Chamber 26 is sufficiently dimensioned to collect a portion of fluid sample F and sediment S. For example, in one embodiment, chamber 26 is dimensioned to collect one (1) ml of fluid sample F after decanting such that sediment S can be resuspended for testing.

Barrel portion 24 includes radially extending ribs 44 that are configured and dimensioned to engage inner surface 18 of test tube 12. Ribs 44 engage inner surface 18 to facilitate stability and support of insert 20 within test tube 12. Ribs 44 also section chamber 26 into equal halves to aid in collection of sediment. Ribs also extend along transition diameter 36. It is contemplated that one or a plurality of ribs 44 may be employed. It is further contemplated that ribs 44 may be variously disposed about insert 20 and can have an intermittent, offset, etc. configuration.

Base portion 22 and barrel portion 24 cooperate to define an interior cavity 46 of insert 20. Interior cavity 46 facilitates passage of fluid sample F to closed end 14 and, upon decanting, back toward open end 16. Barrel portion 24 sufficiently reduces the dimension of interior cavity 46 to facilitate collection of a portion of fluid sample F and sediment S.

Insert 20 is disposed within test tube 12 adjacent closed end 14. This recessed configuration of insert 20 advantageously facilitates capture and collection of sediment disposed adjacent closed end 14 after centrifuge, thereby reducing the effect of practitioner error in the decanting process. It is contemplated that insert 20 may be recessed at various depths within test tube 12 according to the particular requirements of a fluid collection analysis application.

Fluid collection apparatus 10 also includes a cap 48, which is removably mounted to open end 16 of test tube 12. Cap 48 encloses fluid sample F within test tube 12 to retain fluid sample F and prevent hazardous exposure thereto. It is contemplated cap 48 may be threaded, interference fit, etc. with open end 16. It is further contemplated that any or all of the component parts of fluid collection apparatus 10 are disposable.

Referring to FIGS. 7 and 8, in use, a fluid collection apparatus 10, similar to that described, is assembled, properly sterilized and otherwise prepared for storage, shipment and use in a urinalysis procedure. Insert 20 is disposed within test tube 12 forming chamber 26, as described above. Cap 48 is attached to open end 16 to initially prevent contamination and undesired engagement therewith.

Cap 48 is removed and fluid sample F having sediment S, of well-mixed urine from a subject is disposed within test tube 12. It is envisioned that a chemical test of the un-spun fluid sample F may be performed via test strip, etc.

Fluid sample F is centrifuged in test tube 12 until a moderately cohesive button (concentration of urine sediment S, such as a formed bead, pellet, etc.) is produced adjacent closed end 14 of test tube 12. A liquid portion of fluid sample F, such as, for example, supernatant rises and forms above insert 20 within test tube 12. A practitioner (not shown) manipulates test tube 12 in an upright position, as shown in FIG. 7. The practitioner inverts test tube 12, as shown in FIG. 8, to pour off or decant the supernatant.

As test tube 12 is inverted, the button of sediment S comes to rest within chamber 26 as facilitated by barrel portion 24. A portion of fluid sample F, approximately 1 ml, remains within chamber 26. The remaining fluid sample F not captured by chamber 26 passes through interior cavity 46 and is poured off along with the supernatant that form above insert 20, described above. This configuration of fluid collection apparatus 10 advantageously facilitates decanting of supernatant while capturing sediment S.

The button of sediment S is resuspended in the remaining 1 ml portion of fluid sample F. It is contemplated that resuspension may be achieved by, for example, engaging, striking or shaking test tube 12, employing a pipette to aspirate and purge the button and sample in a mixing operation, etc.

The practitioner draws an amount of the resuspended button of sediment S and fluid sample F, using for example, a pipette (not shown). A drop of resuspended sediment S and fluid sample F is disposed onto a glass microscope slide (not shown) and coverslipped (not shown). The glass slide is positioned onto a stage of a microscope (not shown) and examined. It is contemplated that further testing may be performed, including visual inspection, chemical test strips, etc., utilizing fluid collection apparatus 10 in accordance with the principles of the present disclosure. It is further contemplated that the resuspended button of sediment S and fluid sample F may be aspirated into a laboratory fluid analysis workstation, as is known to one skilled in the art, for urinalysis.

Referring to FIGS. 9 and 10, in an alternate embodiment, fluid collection apparatus 10 includes an insert 120, similar to that described above, which is employed with test tube 12. Insert 120 is configured for disposal within test tube 12. Insert 120 includes a first diameter, such as, for example, inner cylinder 112 and a second diameter, such as, for example, outer cylinder 114. Inner cylinder 112 and outer cylinder 114 define a chamber 126 therebetween. Chamber 126 extends from a closed end 128 to an open end 130 that is configured for receipt of a fluid sample F. Insert 120 is disposed within test tube 12 for collecting sediment S from fluid sample F (similar to that shown and described with regard to FIGS. 7 and 8).

Insert 120 advantageously reduces the amount of labor required for a fluid collection application, which thereby reduces the potential for practitioner error. Insert 120 is also configured to retain a portion of fluid sample F, allowing resuspension of sediment S (similar to that shown and described with regard to FIGS. 7 and 8) and facilitating various urinalysis procedures, as will be discussed. It is contemplated that insert 120 may be positioned at various locations along the length of test tube 12.

Chamber 126 has a cylindrical configuration within insert 120 and a uniformly dimensioned radial thickness t. During a urinalysis procedure, chamber 126 collects fluid sample F and sediment S as received through open end 130 and bounded by closed end 120. It is envisioned that chamber 126 may be non-uniform, such as, for example, narrow or broad sectioned, tapered, etc. It is further envisioned that open end 130 may include lateral opening(s) in the wall of inner cylinder 112, or as an alternative.

Outer cylinder 114 is supported by inner surface 18 of test tube 12 for disposal therein. Insert 120 may be manufactured in a manner, size and shape that presents a frictional fit or bias on inner surface 18 of test tube 12. It is contemplated that insert 120 may be ultrasonically welded or fastened using adhesive with inner surface 18. It is contemplated that test tube 12 and insert 120 may be monolithically or separately formed from polymeric materials.

Outer cylinder 114 includes an outer surface 138, which is configured for flush engagement with inner surface 18. It is contemplated that such engagement with inner surface 18 does not require a fluid seal, as chamber 126 is advantageously self-contained with insert 120. It is further contemplated, however, that the engagement may provide a fluid seal. Alternatively, only portions of insert 120 engage inner surface 18, such as, for example, end portions, grooves, tabs, etc.

Inner cylinder 112 defines an interior cavity 146 of insert 120. Inner cylinder 112 includes a base portion 122 and a barrel portion 124 that cooperate to define interior cavity 146. Base portion 122 is substantially tapered, relative to longitudinal axis x of test tube 12, from an end 121 of insert 120 to barrel portion 124. Base portion 122 is tapered at an angle c from longitudinal axis x. It is envisioned that angle c may include various inclinations according to the requirements of a particular application.

Base portion 122 includes a flared portion, such as, for example, flange 140. Flange 140 extends from base portion 122 for engagement with inner surface 18 of test tube 12. Flange 140 facilitates disposal of insert 120 with test tube 12. It is contemplated that flange 140 may be oriented at various angular orientations relative to longitudinal axis x.

Barrel portion 124 is uniformly configured from base portion 122 to an opposite end 123 of insert 120. Barrel portion 124 is in substantially parallel alignment with chamber 126. It is contemplated that barrel portion 124 may be non-uniform, such as, for example, narrow or broad sectioned, tapered, etc. It is further contemplated that barrel portion 124 may extend variable lengths according to the requirement of a particular application.

Interior cavity 146 facilitates passage of fluid sample F to closed end 14 of test tube 12 and, upon decanting, back toward open end 16. Barrel portion 124 sufficiently reduces the dimension of interior cavity 46 to facilitate collection of a portion of fluid sample F and sediment S. It is envisioned that base portion 122 and barrel portion may cooperate to define interior cavity 146 in a substantially tapered configuration that extends along a substantial portion of insert 120, or alternatively, may cooperate to define a uniform, non-tapered configuration, narrow or broad sectioned, etc.

In use, fluid collection apparatus 10 that employs insert 120, similar to that described with regard to FIGS. 7 and 8, is assembled, properly sterilized and otherwise prepared for storage, shipment and use in a urinalysis procedure. Insert 120, defining chamber 126, is disposed within test tube 12. Cap 48 is attached to open end 16 to initially prevent contamination and undesired engagement therewith.

Cap 48 is removed and fluid sample F having sediment S, of mixed urine from a subject is disposed within test tube 12. It is envisioned that a chemical test of the un-spun fluid sample F may be performed via test strip, etc.

Fluid sample F is centrifuged in test tube 12 until a moderately cohesive button (concentration of urine sediment S, such as a formed bead, pellet, etc.) is produced adjacent closed end 14 of test tube 12. A liquid portion of fluid sample F, such as, for example, supernatant rises and forms above insert 20 within test tube 12. A practitioner (not shown) manipulates test tube 12 in an upright position. The practitioner inverts test tube 12 to pour off or decant the supernatant.

As test tube 12 is inverted, the button of sediment S comes to rest within chamber 126 facilitated by open end 130 of chamber 126, as defined by inner cylinder 112 and outer cylinder 114. A portion of fluid sample F, approximately 1 ml, remains within chamber 126. The remaining fluid sample F not captured by chamber 126 passes through interior cavity 146 and is poured off along with the supernatant that form above insert 120. This configuration of fluid collection apparatus 10 advantageously facilitates decanting of supernatant while capturing sediment S.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A fluid collection apparatus comprising:
an insert configured for disposal within a tube, said insert including a first diameter, a second diameter and defining a chamber therebetween, the chamber extending from a closed end to an open end that is configured for receipt of a fluid sample.

2. A fluid collection apparatus as recited in claim 1, wherein said second diameter defines an interior cavity of said insert.

3. A fluid collection apparatus as recited in claim 2, wherein said interior cavity includes a base portion and a barrel portion.

4. A fluid collection apparatus as recited in claim 1, wherein said base portion is substantially tapered relative to a longitudinal axis of said tube.

5. A fluid collection apparatus as recited in claim 1, wherein said barrel portion is uniformly configured.

6. A fluid collection apparatus as recited in claim 1, wherein said chamber is uniformly configured and dimensioned from said closed end to said open end.

7. A fluid collection apparatus as recited in claim 1, wherein said tube defines a longitudinal axis and extends there along from a closed end to an open end said tube further defining an inner surface.

8. A fluid collection apparatus as recited in claim 7, wherein said first diameter engages said inner surface of said tube for disposing said insert between the open end and the closed end of said tube.

9. A fluid collection apparatus as recited in claim 3, wherein said base portion includes a flared portion extending therefrom.

10. A fluid collection apparatus comprising:
a tube defining a longitudinal axis and extending therealong from a closed end to an open end; and
an insert means being disposed within the tube for collecting sediment from a fluid sample.

11. A method for collecting sediment from a fluid sample, the method comprising the steps of:
providing a fluid collection apparatus including:
an insert configured for disposal within a tube, the insert including a first diameter, a second diameter, and defining a chamber therebetween, the chamber extending from a closed end to an open end that is configured for receipt of a fluid sample;
disposing a fluid sample within the tube;
collecting a concentration of sediment from the fluid sample adjacent the closed end of the tube in a first orientation of the tube;
inverting the tube from the first orientation to a second orientation such that at least a portion of the concentration of sediment is disposed with the chamber of the insert.

12. A method for collecting sediment from a fluid sample as recited in claim 11, further comprising the step of decanting a supernatant portion of the fluid sample.

13. A method for collecting sediment from a fluid sample as recited in claim 11, further comprising the step of suspending the portion of the concentration of sediment in a portion of the fluid sample.

14. A method for collecting sediment from a fluid sample as recited in claim 11, further comprising the step of disposing the portion of the concentration of sediment on a microscope slide.

15. A method for collecting sediment from a fluid sample as recited in claim 11, wherein the step of collecting includes centrifuging the fluid sample disposed in the tube.
